(19) United States
(12) Patent Application Publication
(10) Pub. No.: US 2026/0278767 A1
(43) Pub. Date: Sep. 17, 2026

(54) SYSTEM AND METHOD FOR OUTPUTTING IDENTIFICATION INFORMATION ON A WORKPIECE PART

(71) Applicant: TRUMPF Werkzeugmaschinen SE + Co. KG, Ditzingen (DE)

(72) Inventor: Jonathan Eberle, Nufringen (DE)

(21) Appl. No.: 19/670,024

(22) Filed: May 7, 2026

Related U.S. Application Data
(63) Continuation of application No. PCT/EP2024/080750, filed on Oct. 30, 2024.

(30) Foreign Application Priority Data
Nov. 13, 2023 (DE) 10 2023 131 445.9

(51) Int. Cl. G06T 7/00; G06N 3/0455; G06T 7/13; G06V 10/74

(52) U.S. Cl. CPC G06T 7/0004; G06N 3/0455; G06T 7/13; G06V 10/761; G06T 2207/30164

(57) ABSTRACT

A method is for outputting identification information on a workpiece part to be identified from a plurality of workpiece parts, where the workpiece parts each having a cut edge. The method includes generating at least one first image of a part of the cut edge of each workpiece part for each workpiece part of the plurality of workpiece parts; assigning the identification information for each workpiece part to a relevant first image; generating at least one second image of the part of the cut edge of the workpiece part to be identified for the workpiece part to be identified; comparing the second image with a plurality of first images; selecting a first image with a greatest similarity to the at least one second image; and outputting the identification information assigned to the selected first image.

### CROSS REFERENCE TO RELATED APPLICATIONS

This application is a continuation of International Application No. PCT/EP2024/080750 (WO 2025/103772 Al), filed on Oct. 30, 2024, and claims benefit to German Patent Application No. DE 10 2023 131 445.9, filed on Nov. 13, 2023. The aforementioned applications are hereby incorporated by reference herein.

### FIELD

The present disclosure relates to a method for outputting identification information of a workpiece part.

The present disclosure further relates to a system for carrying out a method according to the present disclosure.

### BACKGROUND

DE 10 2017 001 915 A1 discloses a method for identifying at least one component without using identification marks.

### SUMMARY

In an embodiment, the present disclosure provides a method for outputting identification information on a workpiece part to be identified from a plurality of workpiece parts, the workpiece parts each having a cut edge. The method includes: generating at least one first image of a part of the cut edge of each workpiece part for each workpiece part of the plurality of workpiece parts; assigning the identification information for each workpiece part to a relevant first image; generating at least one second image of the part of the cut edge of the workpiece part to be identified for the workpiece part to be identified; comparing the second image with a plurality of first images; selecting a first image with a greatest similarity to the at least one second image; and outputting the identification information assigned to the selected first image.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a sequence of a method according to the present disclosure;

FIG. 2 shows a schematic representation of a system according to the present disclosure;

FIG. 3 shows a further schematic representation of a system according to the present disclosure;

FIG. 4 shows a selection of a part of the cut edge according to the present disclosure; and

FIG. 5 shows a perspective view of a workpiece part according to the present disclosure.

### DETAILED DESCRIPTION

An aspect of the present disclosure provides a method for outputting identification information on a workpiece part to be identified from a plurality of workpiece parts, the workpiece parts each having a cut edge, wherein: at least one first image of at least a part of the cut edge of each workpiece part is generated for each workpiece part of the multitude of workpiece parts; the identification information for each workpiece part is assigned to the relevant first image; at least one second image of at least a part of the cut edge of the workpiece part to be identified is generated for the workpiece part to be identified; the second image is compared with the plurality of first images; the first image with the greatest similarity to the second image is selected, and the identification information saved together with the selected first image is output.

For example, in a first step, a first image of the respective cut edge of each workpiece part is taken from a multitude of workpiece parts. The image of the cut edge then serves as an identification feature of the workpiece part. To identify a workpiece part from the multitude of workpiece parts, an image of the cut edge of the workpiece part to be identified is taken and compared with the first images. Cut edges can be present on both outer and inner contours of the respective workpiece part. A cut edge or part of a cut edge of an outer contour is preferably used for the identification.

In an aspect, the workpiece part to be identified is one of a multitude of workpiece parts. The method is particularly suitable for identifying individual workpiece parts from a plurality of geometrically identical or virtually identical workpiece parts.

In an aspect, the method enables a particularly simple and reliable identification of workpiece parts with cut edges.

In an aspect, workpiece parts cut from sheet metal using a laser cutting machine are preferred. For workpiece parts that have been cut from a sheet of metal using a laser cutting machine, the cut edge is particularly well suited for identifying a workpiece part.

In an aspect, the part of the cut edge for the respective first image and the second image is preferably selected by a predetermined algorithm. By selecting a part of the cut edge, the data requirement compared to mapping the entire cut edge is significantly reduced. The selection is algorithmic, ensuring that the same part of the cut edge is reliably selected for both the first and second images. The selection can be based on properties of the workpiece part. In particular with workpiece parts that have been cut from a sheet of metal using a laser cutting machine, the cut can be selected as the part of the cut edge to be imaged.

In an aspect, the part of the cut edge is preferably selected based on the geometry of the workpiece part. By selecting the geometry, the same part of the cut edge is selected for the first or second image for workpiece parts with the same geometry.

In an aspect, the part of the cut edge is preferably determined based on a surrounding rectangle of minimum area and a centroid of the workpiece part. In particular with sheet metal workpieces, a clear part of the cut edge can be selected very easily and reliably in this way.

In an aspect, a property of the image is preferably determined for the first images and the second image and the properties of the second image are compared with the properties of the first images. By determining and comparing properties, the comparison of images becomes more robust and the identification of the workpiece part more reliable. Properties of the images can include, for example, the geometric relationships of prominent points in the image. Determining the geometric relationships of prominent points in an image is known, for example, from fingerprint or facial recognition.

In an aspect, the properties are preferably determined by means of trained artificial intelligence, in particular an autoencoder. A trained autoencoder allows properties of images of the cut edge to be coded and compared very quickly and reliably.

In an aspect, the second image and the first images are preferably taken at a predetermined distance from the cut edge. The predetermined distance makes it easier to compare geometric relationships in the images. This makes the method more robust.

An aspect of the present disclosure also relates to a system for outputting identification information on a workpiece part to be identified from a plurality of workpiece parts, comprising a camera and a computing unit, wherein the camera is configured to generate at least a first image of at least one part of the cut edge of the respective workpiece part for a multitude of workpiece parts, wherein the camera is communicatively connected with the computing unit and is configured to transmit the first images to the computing unit, wherein the computing unit is configured to assign respective identification information for the respective workpiece part to the first images, wherein the camera is configured to generate and to transmit to the computing unit at least a second image of at least one part of the cut edge of the workpiece part to be identified for the workpiece part to be identified, wherein the computing unit is configured to compare the second image with the plurality of first images, wherein the computing unit is configured to select the first image with the greatest similarity to the second image and to output the identification information assigned to the selected first image via an output interface. The system is able to identify a workpiece part to be identified from a plurality of first workpiece parts and to output the assigned identification information. The computing unit can be part of a machine tool for cutting out workpiece parts. Alternatively, the computing unit can be part of a factory control system. Alternatively, the computing unit can be part of a remote computing system, e.g., a cloud. Alternatively, the computing unit can consist of a plurality of distributed computing units, wherein a plurality of the distributed computing units are configured to perform different steps of a method according to the present disclosure.

In an aspect, the computing unit is preferably configured to compare the second image with the plurality of first images using a predetermined algorithm.

In an aspect, the system preferably comprises a data storage device, wherein the computing unit is configured to store the first images and/or a respective property of the first images together with the respective assigned identification information on the data storage device. By using the data storage device, the information required for identification can be stored permanently.

In an aspect, the computing unit is preferably configured to determine the respective property of the first images by means of a predetermined algorithm, in particular by means of an autoencoder.

The following description of example, preferred embodiments serves to explain the invention in greater detail with reference to the drawings.

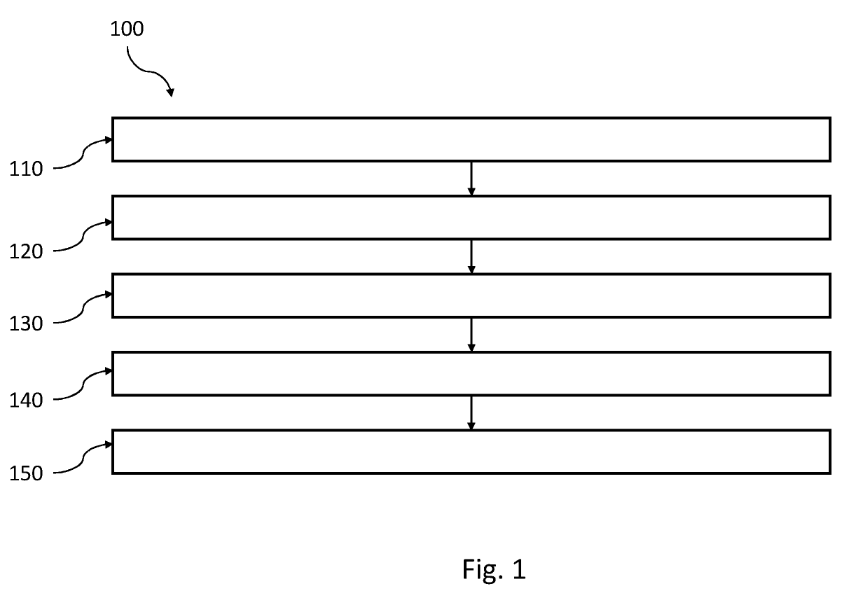

Elements that are the same or have equivalent functions are denoted by the same reference signs in all the exemplary embodiments. FIG. 1 shows an exemplary sequence 100 of a method according to the present disclosure. In a first step 110, a first image 6 of each workpiece part 20 is generated using a camera 5. In a second step 120, each first image 5 is assigned identification information 50. In a third step 130, a second image 7 of the workpiece part 21 to be identified is generated. In a fourth step 140, the first image 6 with the greatest similarity to the second image 7 is selected. In a fifth step 150, the identification information 50 assigned to the selected first image 6 is output.

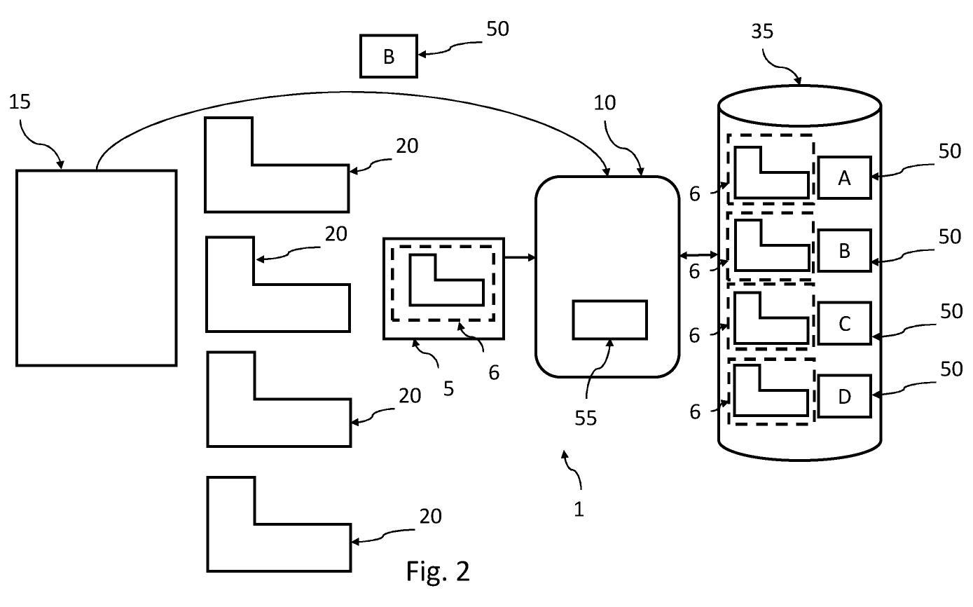

In connection with the schematic representation of a system 1 shown in FIG. 2, the first two steps 110, 120 are described in more detail. The system 1 comprises a camera 5 and a computing unit 10. A multitude of workpiece parts 20 are manufactured by a machine tool 15, here a laser cutting machine. The workpiece parts 20 are geometrically virtually identical and have a cut edge on their outer contour. In the first step 110, the camera 5 of the system 1 generates a first image 6 of the cut edge or of a part of the cut edge. The first images 6 are transmitted from the camera 5 to the computing unit 10. In the second step 120, the computing unit 10 assigns identification information 50 to each first image 6. In this example, the identification information 50 is transmitted from the laser cutting machine 15 to the computing unit 10. Alternatively, the identification information 50 could be input by an operator of the computing unit 10. For a simple and reliable comparison of the first images 6 with the second image 7, an autoencoder 55 is used in this example by the computing unit 10. The autoencoder 55 is used to encode characteristic features of the cut edge in the respective image. The computing unit 10 stores the first images 6, or the characteristic features encoded by the autoencoder, together with the respective identification information 50 in a data storage device 35.

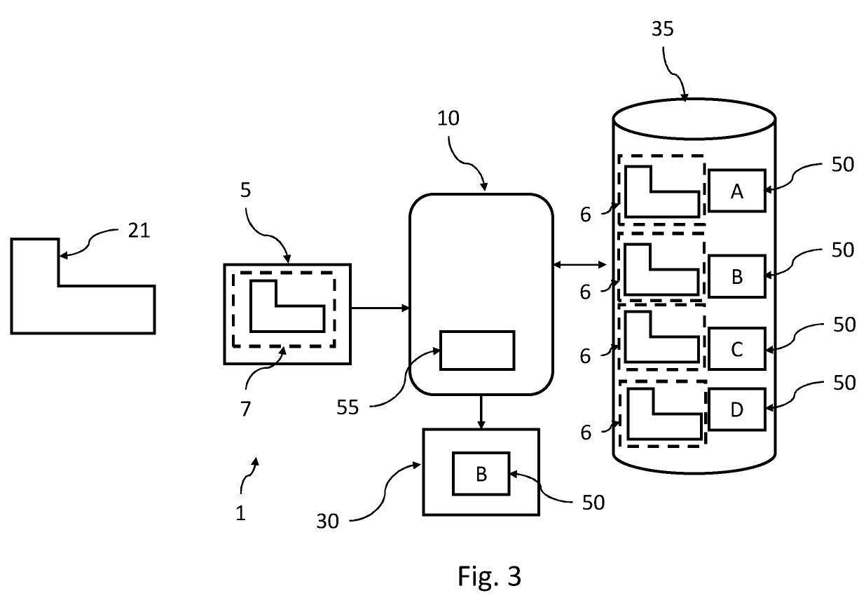

In connection with the schematic representation of a system 1 shown in FIG. 3, the third step 130, the fourth step 140 and the fifth step 150 are described in more detail. In the third step, the camera 5 of the system 1 generates a second image 7 of the cut edge, or part of the cut edge, of the workpiece part 21 to be identified. The second image 7 is transmitted by the camera 5 to the computing unit 10. In the fourth step 140, the computing unit 10 compares the second image 7 with the first images 6 and selects the first image 6 with the greatest similarity to the second image 7. In this example, for comparison with the autoencoder 55, the characteristic features of the second image 7 are encoded and compared with the encoded characteristic features of the first images 6 stored in the data storage device 35. In the fifth step 150, the computing unit loads the assigned identification information 50 for the selected first image 6 from the data storage device and outputs the identification information 50 via an output interface 30. In this example, the output interface 30 is a screen. Alternatively, the output interface 30 can be connected to a machine, in particular a machine tool, e.g., a bending machine, a deburring machine, or a marking machine. The direct connection allows the machine to be informed how to handle the workpiece part 21 to be identified in question.

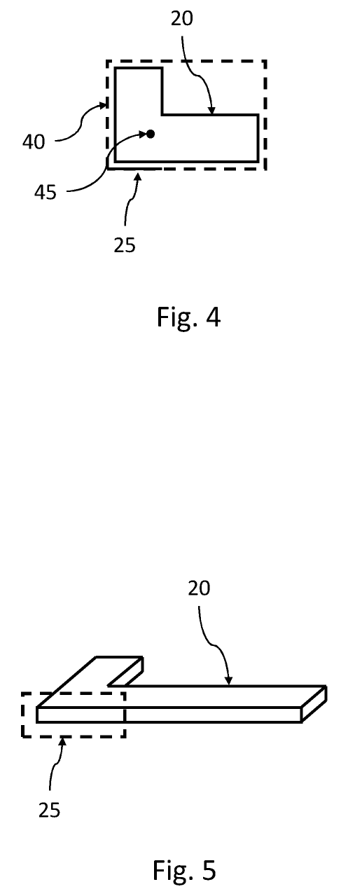

FIG. 4 shows a selection of a part 25 of the cut edge. In order to avoid having to map the entire cut edge of the workpiece part 20 in the first image 6 or second image 7, a part 25 of the cut edge is preferably selected. The selection of the part 25 of the cut edge is preferably based on a geometric property of the workpiece part 30. In this example, the part 25 is selected based on a surrounding rectangle 40 of minimum area and the centroid 45 of the workpiece part 20. For the surrounding rectangle 40 with minimum area, of all possible surrounding rectangles the one with the smallest area is selected. The workpiece part 20 with the surrounding rectangle 40 of minimum area is then aligned such that the centroid 45 of the workpiece part 20 lies below and to the left of the center point of the surrounding rectangle 40. From the component thus aligned, a predetermined length of the cut edge at the bottom left is selected as the part 25 of the cut edge for the first image 6 or second image 7. For workpiece parts 20 where the selection of the part 25 of the cut edge is not clear using the method shown here, further or other criteria can be used for the selection. A preferred criterion is the intersection point of the contour.

FIG. 5 shows a perspective view of the workpiece part 20 from FIG. 4. The thickness of the cut edge is visible in the perspective view. The dashed outline shows part 25 of the cut edge, which is selected for the illustration in the first image 6, or in the second image 7.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

100 Method sequence

110 First step

120 Second step

130 Third step

140 Fourth step

150 Fifth step

1 System

5 Camera

6 First image

7 Second image

10 Computing unit

15 Laser cutting machine

20 Workpiece part

25 Part of the cut edge

21 Workpiece part to be identified

30 Output interface

35 Data storage device

40 Surrounding rectangle

45 Centroid

50 Identification information

55 Autoencoder

1. A method for outputting identification information on a workpiece part to be identified from a plurality of workpiece parts, the workpiece parts each having a cut edge, the method comprising:
generating at least one first image of a part of the cut edge of each workpiece part for each workpiece part of the plurality of workpiece parts;
assigning the identification information for each workpiece part to a relevant first image;
generating at least one second image of the part of the cut edge of the workpiece part to be identified for the workpiece part to be identified;
comparing the second image with a plurality of first images;
selecting a first image with a greatest similarity to the at least one second image; and
outputting the identification information assigned to the selected first image.

2. The method according to claim 1, wherein the plurality of workpiece parts are sheet metal workpiece parts cut from a sheet by a laser cutting machine.

3. The method according to claim 1, wherein the part of the cut edge for a respective first image and the second image is selected by a predetermined algorithm.

4. The method according to claim 3, wherein the part of the cut edge is selected based on a geometric property of the workpiece part.

5. The method according to claim 4, wherein the part of the cut edge is determined based on a surrounding rectangle of minimum area and a centroid of the workpiece part.

6. The method according to claim 1, wherein a property of an image is determined for each of the first images and the second image and properties of the second image are compared with the properties of the first images.

7. The method according to claim 6, wherein the properties are determined by means of trained artificial intelligence comprising an autoencoder.

8. The method according to claim 1, wherein the second image and the plurality of first images are taken at a predetermined distance from the cut edge.

9. A system for outputting identification information on a workpiece part to be identified from a plurality of workpiece parts, comprising:
a camera communicatively connected with a computing unit, the camera configured to:
generate at least one first image of a part of a cut edge of each workpiece part for the plurality of workpiece parts;
transmit a plurality of first images to the computing unit; and
generate and transmit, to the computing unit, a second image of the part of the cut edge of the workpiece part to be identified for the workpiece part to be identified, and
the computing unit, configured to:
assign respective identification information for the respective workpiece part to the first images;
compare the second image with the plurality of first images; and
select a first image with a greatest similarity to the second image and output the identification information assigned to the selected first image via an output interface.

10. The system according to claim 9, wherein the computing unit is configured to compare the second image with the plurality of first images by a predetermined algorithm.

11. The system according to claim 9, wherein the system comprises a data storage device, wherein the computing unit is configured to store the plurality first images and/or a respective property of the plurality of first images together with the respective assigned identification information on the data storage device.

12. The system according to claim 9, wherein the computing unit is configured to determine a respective property of the plurality of first images by a predetermined algorithm comprising an autoencoder.
